(19) United States
(12) Patent Application Publication
(10) Pub. No.: US 2019/0205616 A1
(43) Pub. Date: Jul. 4, 2019

(54) METHOD AND APPARATUS FOR DETECTING FACE OCCLUSION

(71) Applicant: Baidu Online Network Technology (Beijing) Co., Ltd., Beijing (CN)

(72) Inventor: Zhibin Hong, Beijing (CN)

(21) Appl. No.: 16/131,870

(22) Filed: Sep. 14, 2018

(30) Foreign Application Priority Data
Dec. 29, 2017 (CN) 201711476846.2

(51) Int. Cl. G06K 9/00

(52) U.S. Cl. CPC G06K 9/00228; G06K 9/00288; G06K 9/00281

(57) ABSTRACT

A method and apparatus for detecting face occlusion. A specific embodiment of the method includes: acquiring a to-be-processed face occlusion image, the to-be-processed face occlusion image containing a plurality of feature points for marking a facial feature; importing the to-be-processed face occlusion image into a pre-trained face occlusion model to obtain occlusion information corresponding to the to-be-processed face occlusion image, the face occlusion model being used to acquire occlusion information of a face by the feature points contained in the to-be-processed face occlusion image; and outputting the occlusion information. In this embodiment, the acquired to-be-processed face occlusion image containing feature points is imported into a face occlusion model, and the occlusion information of the to-be-processed face occlusion image can be obtained quickly and accurately, thus improving the efficiency and accuracy of acquiring the occlusion information.

### CROSS-REFERENCE TO RELATED APPLICATIONS

This application claims priority to Chinese Patent Application No. 201711476846.2, filed with the State Intellectual Property Office of the People's Republic of China (SIPO) on Dec. 29, 2017, the content of which is incorporated herein by reference in its entirety.

### TECHNICAL FIELD

Embodiments of the present disclosure relate to the field of computer technology, specifically relate to the field of image recognition technology, and more specifically relate to a method and apparatus for detecting facial occlusion.

### BACKGROUND

Facial recognition technology is a computer application research technology, belonging to biometric feature recognition technology. The biological features of a biological individual can not only provide distinctions for the biological individual, but also an estimate of the physical state of the biological individual. When performing facial recognition, a clear face image needs to be acquired first when the light is sufficient, and then data processing is performed on the face image.

### SUMMARY

The objective of embodiments of the present disclosure is to propose a method and apparatus for detecting face occlusion.

In a first aspect, the embodiments of the present disclosure provide a method for detecting face occlusion, including: acquiring a to-be-processed face occlusion image, the to-be-processed face occlusion image containing a plurality of feature points for marking a facial feature; importing the to-be-processed face occlusion image into a pre-trained face occlusion model to obtain occlusion information corresponding to the to-be-processed face occlusion image, the face occlusion model being used to acquire occlusion information of a face by the feature points contained in the to-be-processed face occlusion image; and outputting the occlusion information.

In some embodiments, the method further includes constructing the face occlusion model, and the constructing the face occlusion model include: dividing, for each sample face occlusion image in a plurality of sample face occlusion images, a face image in the sample face occlusion image into at least one face area by feature points of the face image, wherein the each sample face occlusion image contains pre-marked feature points; calculating, for each face area in the at least one face area, a ratio of non-face pixels in the face area to all pixels in the face area to obtain ratio information, and constructing occlusion information of the face area by the ratio information; and obtaining the face occlusion model through training, by using a machine learning method, with the sample face occlusion image as an input, and the occlusion information of each face area in the sample face occlusion image as an output.

In some embodiments, the dividing a face image in the sample face occlusion image into at least one face area by feature points of the face image includes: importing the sample face occlusion image into a pixel recognition model to obtain a label of a pixel of the sample face occlusion image, wherein the pixel recognition model is used to recognize whether a pixel belongs to the face image, and set a label for the pixel, and the label is used to annotate whether the pixel belongs to the face image; dividing the sample face occlusion image into the face image and a non-face image by the label; and dividing the face image into the at least one face area by the feature points.

In some embodiments, the method further includes constructing the pixel recognition model, and the constructing the pixel recognition model include: performing feature extraction on the sample face occlusion image to acquire a feature image, the feature image having a size smaller than the sample face occlusion image; determining a feature image area corresponding to a facial feature on the feature image, the facial feature including hair, eyebrows, eyes, and nose; setting, after mapping the feature image to a size identical to the sample face occlusion image, a face area label for a pixel included in the feature image area, and setting a non-face area label for a pixel not included in the feature image area; and obtaining the pixel recognition model by training, by using the machine learning method, with the sample face occlusion image as an input, and the face area label or the non-face area label of each pixel in the sample face occlusion image as an output.

In some embodiments, before the acquiring a to-be-processed face occlusion image, the method further includes: performing image processing on the to-be-processed face occlusion image to recognize the facial feature, and setting the feature points for the facial feature on the to-be-processed face occlusion image.

In a second aspect, the embodiments of the present disclosure provide an apparatus for detecting face occlusion, including: an image acquisition unit, configured to acquire a to-be-processed face occlusion image, the to-be-processed face occlusion image containing a plurality of feature points for marking a facial feature; a occlusion information acquisition unit, configured to import the to-be-processed face occlusion image into a pre-trained face occlusion model to obtain occlusion information corresponding to the to-be-processed face occlusion image, the face occlusion model being used to acquire occlusion information of a face by the feature points contained in the to-be-processed face occlusion image; and an information output unit, configured to output the occlusion information.

In some embodiments, the apparatus further includes a face occlusion model construction unit, configured to construct the face occlusion model, and the face occlusion model construction unit includes: a face area dividing subunit, configured to divide, for each sample face occlusion image in a plurality of sample face occlusion images, a face image in the sample face occlusion image into at least one face area by feature points of the face image, wherein the each sample face occlusion image contains pre-marked feature points; a occlusion information acquisition subunit, configured to calculate, for each face area in the at least one face area, a ratio of non-face pixels in the face area to all pixels in the face area to obtain ratio information, and construct occlusion information of the face area by the ratio information; and a face occlusion model construction subunit, configured to obtain the face occlusion model through training, by using a machine learning method, with the sample face occlusion image as an input, and the occlusion information of each face area in the sample face occlusion image as an output.

In some embodiments, the face area dividing subunit includes: a label acquisition module, configured to import the sample face occlusion image into a pixel recognition model to obtain a label of a pixel of the sample face occlusion image, wherein the pixel recognition model is used to recognize whether a pixel belongs to the face image, and set a label for the pixel, and the label is used to annotate whether the pixel belongs to the face image; an image dividing module, configured to divide the sample face occlusion image into the face image and a non-face image by the label; and a face area dividing module, configured to divide the face image into the at least one face area by the feature points.

In some embodiments, the apparatus further includes a pixel recognition model construction unit, configured to construct the pixel recognition model, and the pixel recognition model construction unit includes: a feature image acquisition subunit, configured to perform feature extraction on the sample face occlusion image to acquire a feature image, the feature image having a size smaller than the sample face occlusion image; a feature image area determination subunit, configured to determine a feature image area corresponding to a facial feature on the feature image, the facial feature including hair, eyebrows, eyes, and nose; a label setting subunit, configured to set, after mapping the feature image to a size identical to the sample face occlusion image, a face area label for a pixel included in the feature image area, and set a non-face area label for a pixel not included in the feature image area; and a pixel recognition model construction subunit, configured to obtain the pixel recognition model by training, by using the machine learning method, with the sample face occlusion image as an input, and the face area label or the non-face area label of each pixel in the sample face occlusion image as an output.

In some embodiments, the apparatus further includes: perform image processing on the to-be-processed face occlusion image to recognize the facial feature, and set the feature points for the facial feature on the to-be-processed face occlusion image.

In a third aspect, the embodiments of the present disclosure provide a terminal device, including: one or more processors; and a storage apparatus, for storing one or more programs, the one or more programs, when executed by the one or more processors, cause the one or more processors to implement the method for detecting face occlusion according to the first aspect.

In a fourth aspect, the embodiments of the present disclosure provide a computer readable storage medium, storing a computer program thereon, the program, when executed by a processor, implements the method for detecting face occlusion according to the first aspect.

The method and apparatus for detecting face occlusion provided by the embodiments of the present disclosure imports the acquired to-be-processed face occlusion image containing feature points into a face occlusion model, and the occlusion information of the to-be-processed face occlusion image can be obtained quickly and accurately, thus improving the efficiency and accuracy of acquiring the occlusion information.

### BRIEF DESCRIPTION OF THE DRAWINGS

After reading detailed descriptions of non-limiting embodiments with reference to the following accompanying drawings, other features, objectives and advantages of the present disclosure will become more apparent:

FIG. 1 is an exemplary system architecture diagram to which the present disclosure may be applied;

FIG. 2 is a flowchart of an embodiment of a method for detecting face occlusion according to the present disclosure;

FIG. 3 is a schematic diagram of an application scenario of the method for detecting face occlusion according to the present disclosure;

FIG. 4 is a schematic structural diagram of an embodiment of an apparatus for detecting face occlusion according to the present disclosure; and

FIG. 5 is a schematic structural diagram adapted to implement a terminal device of the embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

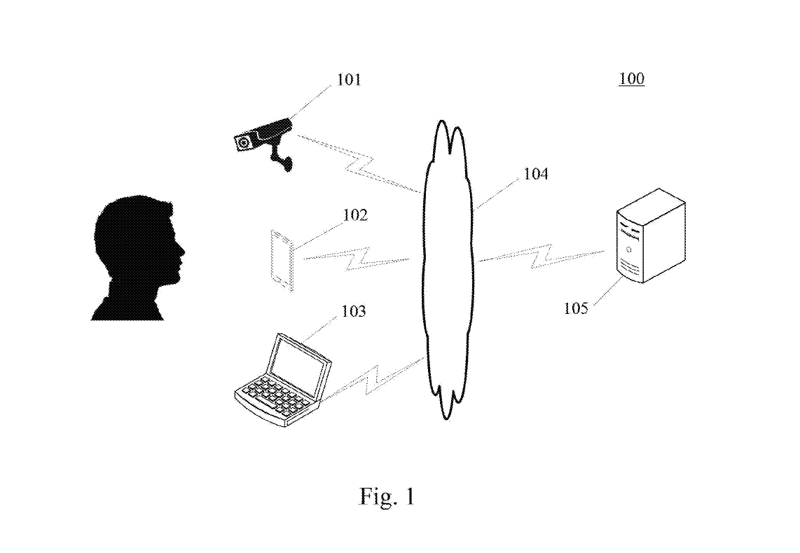

FIG. 1 shows an exemplary architecture of a system 100 in which a method for detecting face occlusion or an apparatus for detecting face occlusion according to the embodiments of the present disclosure.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, such as wired or wireless transmission links, or optical fibers.

The user 110 may use the terminal devices 101, 102 and 103 to interact with the server 105 through the network 104, in order to transmit or receive messages, etc. Various communication client applications, such as camera applications, video capturing application, image conversation applications or near-infrared processing applications, may be installed on the terminal devices 101, 102 and 103.

The terminal devices 101, 102 and 103 may be various electronic devices having display screen and supporting image capturing, including but not limited to, IP cameras, surveillance cameras, smart phones, tablet computers, laptop computers and desktop computers.

The server 105 may be a server providing various services, for example, a server performing processing on the to-be-processed face occlusion image captured by the terminal devices 101, 102 or 103. The server may perform a corresponding data processing on the received to-be-processed face occlusion image, and return a processing result to the terminal devices 101, 102 and 103.

It should be noted that the method for detecting face occlusion according to the embodiments of the present disclosure is generally executed by the terminal devices 101, 102 and 103. Accordingly, an apparatus for detecting face occlusion is generally installed on the terminal devices 101, 102 and 103.

It should be appreciated that the numbers of the terminal devices, the networks and the servers in FIG. 1 are merely illustrative. Any number of terminal devices, networks and servers may be provided based on the actual requirements.

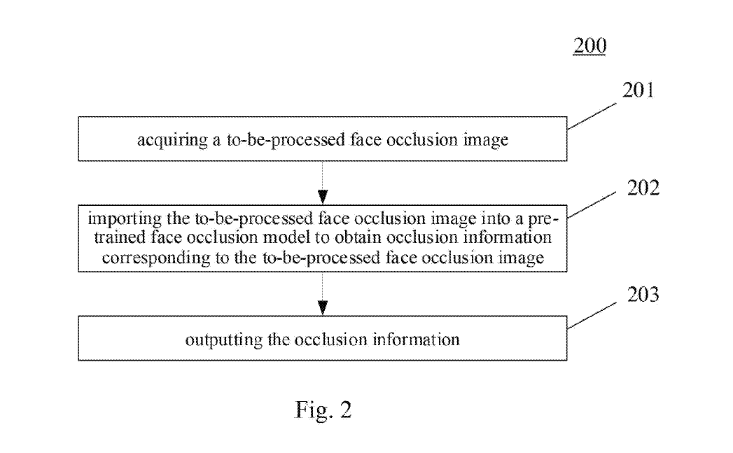

With further reference to FIG. 2, a flow 200 of an embodiment of the method for detecting face occlusion according to the present disclosure is illustrated. The method for detecting face occlusion includes the following steps:

Step 201, acquiring a to-be-processed face occlusion image.

In the present embodiment, the electronic device (e.g., the terminal devices 101, 102, 103 as shown in FIG. 1) on which the method for detecting face occlusion operate may receive a to-be-processed face occlusion image from the terminal with which the user acquires the image through a wired connection or a wireless connection. Here, the to-be-processed face occlusion image contains a plurality of feature points for marking a facial feature. It should be noted that the wireless connection may include, but is not limited to, 3G/4G connection, WiFi connection, Bluetooth connection, WiMAX connection, Zigbee connection, UWB (ultra wideband) connection, and other wireless connections known by now or to be developed in the future.

The terminal devices 101, 102, 103 may acquire a to-be-processed face occlusion image through a wired connection or a wireless connection. The to-be-processed face occlusion image contains a face image that is partially occluded. In addition, the to-be-processed face occlusion image further includes a plurality of feature points for marking the face image. Here, the feature points correspond to the facial feature, and under normal conditions, each face has the same number of facial features on similar positions (i.e., the facial features can be determined even if the face is occluded). Therefore, the feature points of the present embodiment may be used to mark facial features in the un-occluded face image and facial feature the occluded face image. For example, if the un-occluded part of the face image of the to-be-processed face occlusion image is the image corresponding to the mouth, the feature points may still mark the occluded mouth image.

Step 202, importing the to-be-processed face occlusion image into a pre-trained face occlusion model to obtain occlusion information corresponding to the to-be-processed face occlusion image.

In the present embodiment, the electronic device may store a pre-trained face occlusion model. After acquiring the to-be-processed face occlusion image, the electronic device may import the to-be-processed face occlusion image into the pre-trained face occlusion model to obtain occlusion information corresponding to the to-be-processed face occlusion image. Here, the face occlusion model is used to acquire occlusion information of a face by the feature points contained in the to-be-processed face occlusion image. For example, the face occlusion model may be a correspondence relationship table pre-established by a technician based on statistics of a large number of face occlusion images and occlusion information, and storing correspondence relationships between the face occlusion images and the occlusion information; or a may be a calculation formula for performing numerical calculation on the face occlusion images to obtain a calculation result characterizing the occlusion information and pre-stored to the electronic device by a technician based on statistics of a large number of data.

In some alternative implementations of the present embodiment, the method may further include constructing the face occlusion model, and the constructing the face occlusion model may include the following steps:

The first step, dividing, for each sample face occlusion image in a plurality of sample face occlusion images, a face image in the sample face occlusion image into at least one face area by feature points of the face image.

The electronic device may acquire a plurality of sample face occlusion images, and the plurality of sample face occlusion images contain various possible occlusion situations. Here, each sample face occlusion image contains pre-marked feature points. For each sample face occlusion image in the plurality of sample face occlusion images, since the feature points are used to mark the facial feature, the electronic device may divide the face image into at least one face area by the feature points of the face image in the sample face occlusion image. Here, the at least one face area is combined to form the face image, and each face area may include at least one facial feature.

The second step, calculating a ratio of non-face pixels in a face area to all pixels in the face area to obtain ratio information, for each face area in the at least one face area, and constructing occlusion information of the face area by the ratio information.

In order to accurately acquire the occlusion information, the present embodiment acquires the occlusion information in units of face areas. When acquiring the occlusion information, the present disclosure calculates the ratio of non-face pixels in the corresponding face area to all pixels in the face area to obtain ratio information of the face area being occluded, and then constructs occlusion information of the face area by using the ratio information. For example, if the ratio information of the face area A1 (for example, the left face) being occluded is 40′, the occlusion information constructed by the ratio information may be: “Your left face is occluded by 40%, please adjust your position.”

The third step, obtaining the face occlusion model through training, by using a machine learning method, with the sample face occlusion image as an input, and the occlusion information of each face area in the sample face occlusion image as an output.

The electronic device may obtain the face occlusion model through training, by using a machine learning method, with the sample face occlusion image as an input, and the occlusion information of each face area in the sample face occlusion image as an output. Specifically, the electronic device may use a model for classification such as a convolutional neural network, a deep learning model, a Naive Bayesian Model (NBM) or a Support Vector Machine (SVM), with the sample face occlusion image as the input of the model, and the occlusion information of each face area in the sample face occlusion image as the output of the model, train the model to obtain the face occlusion model by using the machine learning method.

After the face occlusion model is obtained, and after the to-be-processed face occlusion image is input to the face occlusion model, the face occlusion model may find a matching sample face occlusion image corresponding to the to-be-processed face occlusion image (the occlusion types are same or similar), and the occlusion information of the sample face occlusion image is directly used as the occlusion information of the to-be-processed face occlusion image to output, thereby greatly reducing the data amount processed in acquiring the occlusion information of the to-be-processed face occlusion image, and improving the efficiency and accuracy of acquiring the occlusion information.

In some alternative implementations of the present embodiment, the dividing a face image in the sample face occlusion image into at least one face area by feature points of the face image may include the following steps:

The first step, importing the sample face occlusion image into a pixel recognition model to obtain a label of a pixel of the sample face occlusion image.

The pixel recognition model may be used to recognize whether a pixel belongs to a face image and to set a label for the pixel. For example, the pixel recognition model may be a correspondence relationship table pre-established by a technician based on statistics of a large number of sample face occlusion images and the label of each pixel of the sample face occlusion image, and storing correspondence relationships between the sample face occlusion images and the label of each pixel of the sample face occlusion image; or a may be a calculation formula for performing numerical calculation on the one or more values in the sample face occlusion images to obtain a calculation result characterizing the label of each pixel and pre-stored to the electronic device by a technician based on statistics of a large number of data. Here, the label may be used to annotate whether the pixel belongs to the face image. For example, when the value of the label is 1, the pixel may be considered as belonging to a face image; when the value of the label is 0, the pixel may be considered as not belonging to a face image. The label may also annotate whether the pixel belongs to a face image by means of text or characters, and detailed descriptions thereof will be omitted.

The second step, dividing the sample face occlusion image into a face image and a non-face image by the label.

After obtaining the label of each pixel, the sample face occlusion image may be divided into a face image and a non-face image according to the classification of the label (i.e., the pixel belongs to a face image or does not belong to a face image).

The third step, dividing the face image into the at least one face area by the feature points.

The face image obtained is an image including only the face, and the non-face image is an image not including the face. Then, the face image may be divided into at least one face area by the feature points. It should be noted that the feature points may be used to mark the un-occluded face image and the facial feature in the occluded face image. Therefore, the face area obtained by dividing by the feature points may include three cases. The first case is: a face area only contains the face image; the second case is: a face area contains both the face image and the non-face image; the third case is: a face area only contains the non-face image.

In some alternative implementations of the present embodiment, the method may further include constructing the pixel recognition model, and the constructing the pixel recognition model may include the following steps:

The first step, performing feature extraction on the sample face occlusion image to acquire a feature image.

In order to determine which pixels in the sample face occlusion image belong to the face image and which pixels belong to the non-face image, the electronic device may perform feature extraction on the sample face occlusion image to acquire a feature image. Here, the feature image includes a facial feature, and the feature image has a size smaller than the sample face occlusion image.

The second step, determining a feature image area corresponding to a facial feature on the feature image.

As can be seen from the above description, the size of the feature image is smaller than the sample face occlusion image. Therefore, a feature image area corresponding to the facial feature may be relatively accurately determined on the feature image. Here, the facial feature includes hair, eyebrows, eyes, nose and the like. The feature image area may be an image area containing a facial feature.

The third step, after mapping the feature image to a size identical to the sample face occlusion image, setting a face area label for a pixel included in the feature image area, and setting a non-face area label for a pixel not included in the feature image area.

After the feature image area is determined on the feature image, the feature image is mapped to the same size as the sample face occlusion image. In this way, it is possible to accurately determine which pixels belong to the face area and which pixels do not belong to the face area through the mapped feature image area. Then, a face area label may be set for each pixel included in the feature image area, and a non-face area label may be set for each pixel not included in the feature image area. In this way, the setting a label for each pixel of the sample face occlusion image is realized.

The fourth step, obtaining the pixel recognition model by training, by using the machine learning method, with the sample face occlusion image as an input, and the face area label or the non-face area label of each pixel in the sample face occlusion image as an output.

The electronic device of the present embodiment may obtain the pixel recognition model by training, by using the machine learning method, with the sample face occlusion image as an input, and the face area label or the non-face area label of each pixel in the sample face occlusion image as an output. Specifically, the electronic device may use a model such as a convolutional neural network, a deep learning model, a Naive Bayesian Model (NBM) or a Support Vector Machine (SVM), with the sample face occlusion image as the input of the model, and the face area label or the non-face area label of each pixel in the sample face occlusion image as the output of the model, train the model to obtain the pixel recognition model using the machine learning method.

Step 203, outputting the occlusion information.

Through the above steps, after the to-be-processed face occlusion image is imported into the pre-trained face occlusion model, the occlusion information corresponding to the to-be-processed face occlusion image may be obtained quickly and accurately. Then, the occlusion information may be output by text, image, or audio.

In some alternative implementations of the present embodiment, before the acquiring a to-be-processed face occlusion image, the method may further include: performing image processing on the to-be-processed face occlusion image to recognize the facial feature, and setting the feature points for the facial feature on the to-be-processed face occlusion image.

As can be seen from the above description, feature points play an important role in the process of acquiring occlusion information. Generally, the electronic device acquires a to-be-processed face occlusion image that does not include a feature point. That is, when the image capturing device directly acquires a to-be-processed face occlusion image, the to-be-processed face occlusion image does not include a feature point. To this end, it is also necessary to perform image processing such as facial recognition on the to-be-processed face occlusion image, and recognize the facial features. Then, feature points are set for the facial features on the to-be-processed face occlusion image.

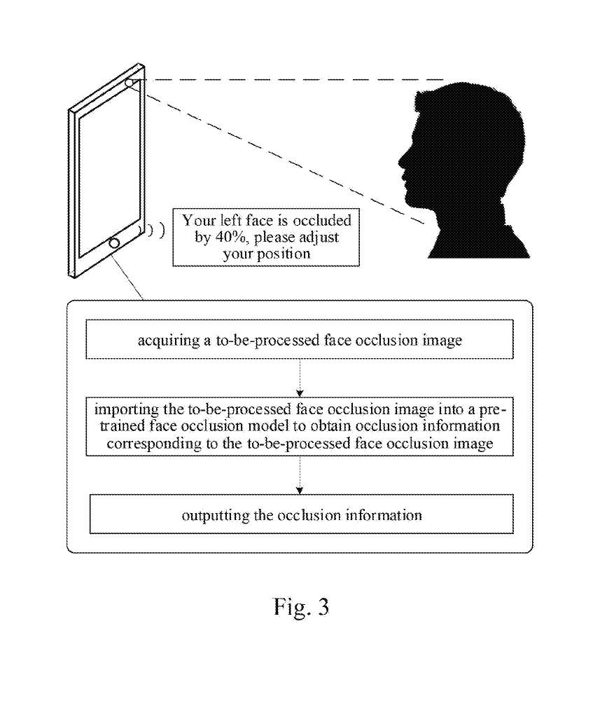

With further reference to FIG. 3, a schematic diagram of an application scenario of the method for detecting face occlusion according to the present embodiment is illustrated. In the application scenario of FIG. 3, after the terminal device acquires the to-be-processed face occlusion image, the to-be-processed face occlusion image is input into the face occlusion model to obtain the occlusion information “Your left face is occluded by 40%, please adjust your position”, then the terminal device may play the occlusion information by voice.

The method provided by the embodiments of the present disclosure imports the acquired to-be-processed face occlusion image containing feature points into a face occlusion model, and the occlusion information of the to-be-processed face occlusion image can be obtained quickly and accurately, thus improving the efficiency and accuracy of acquiring the occlusion information.

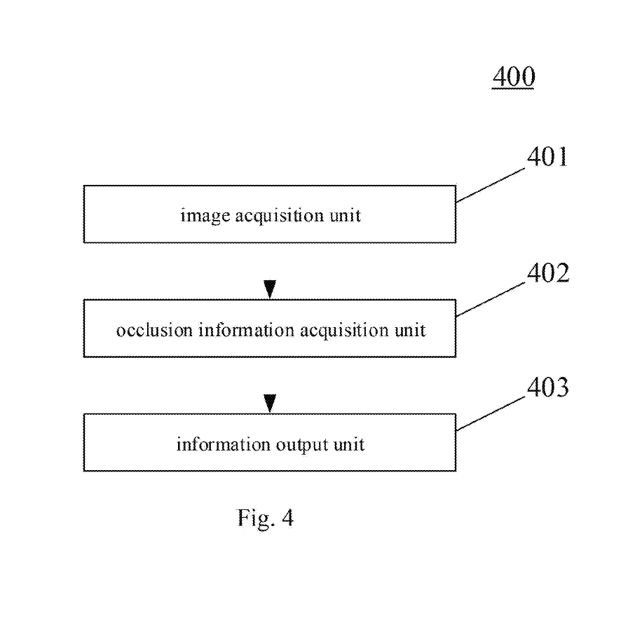

With further reference to FIG. 4, as an implementation to the method shown in the above figures, the present disclosure provides an embodiment of an apparatus for detecting face occlusion. The apparatus embodiment corresponds to the method embodiment shown in FIG. 2, and the apparatus may specifically be applied to various electronic devices.

As shown in FIG. 4, the apparatus 400 for detecting face occlusion of the present embodiment may include: an image acquisition unit 401, a occlusion information acquisition unit 402 and an information output unit 403. The image acquisition unit 401 is configured to acquire a to-be-processed face occlusion image, the to-be-processed face occlusion image containing a plurality of feature points for marking a facial feature. The occlusion information acquisition unit 402 is configured to import the to-be-processed face occlusion image into a pre-trained face occlusion model to obtain occlusion information corresponding to the to-be-processed face occlusion image, the face occlusion model being used to acquire occlusion information of a face by the feature points contained in the to-be-processed face occlusion image. The information output unit 403 is configured to output the occlusion information.

In some alternative implementations of the present embodiment, the apparatus 400 for detecting face occlusion may further include a face occlusion model construction unit (not shown in the figure), configured to construct the face occlusion model, and the face occlusion model construction unit may include: a face area dividing subunit (not shown in the figure), a occlusion information acquisition subunit (not shown in the figure) and a face occlusion model construction subunit (not shown in the figure). The face area dividing subunit is configured to divide, for each sample face occlusion image in a plurality of sample face occlusion images, a face image in the sample face occlusion image into at least one face area by feature points of the face image, wherein the each sample face occlusion image contains pre-marked feature points. The occlusion information acquisition subunit is configured to calculate, for each face area in the at least one face area, a ratio of non-face pixels in the face area to all pixels in the face area to obtain ratio information, and construct occlusion information of the face area by the ratio information. The face occlusion model construction subunit is configured to obtain the face occlusion model through training, by using a machine learning method, with the sample face occlusion image as an input, and the occlusion information of each face area in the sample face occlusion image as an output.

In some alternative implementations of the present embodiment, the face area dividing subunit may include: a label acquisition module (not shown in the figure), an image dividing module (not shown in the figure) and a face area dividing module (not shown in the figure). The label acquisition module is configured to import the sample face occlusion image into a pixel recognition model to obtain a label of a pixel of the sample face occlusion image, wherein the pixel recognition model is used to recognize whether a pixel belongs to the face image, and set a label for the pixel, and the label is used to annotate whether the pixel belongs to the face image. The image dividing module is configured to divide the sample face occlusion image into the face image and a non-face image by the label. The face area dividing module is configured to divide the face image into the at least one face area by the feature points.

In some alternative implementations of the present embodiment, the apparatus 400 for detecting face occlusion may further include a pixel recognition model construction unit (not shown in the figure), configured to construct the pixel recognition model, and the pixel recognition model construction unit may include: a feature image acquisition subunit (not shown in the figure), a feature image area determination subunit (not shown in the figure), a label setting subunit (not shown in the figure) and a pixel recognition model construction subunit (not shown in the figure). The feature image acquisition subunit is configured to perform feature extraction on the sample face occlusion image to acquire a feature image, the feature image having a size smaller than the sample face occlusion image. The feature image area determination subunit is configured to determine a feature image area corresponding to a facial feature on the feature image, the facial feature including hair, eyebrows, eyes, and nose. The label setting subunit is configured to set, after mapping the feature image to a size identical to the sample face occlusion image, a face area label for a pixel included in the feature image area, and set a non-face area label for a pixel not included in the feature image area. The pixel recognition model construction subunit is configured to obtain the pixel recognition model by training, by using the machine learning method, with the sample face occlusion image as an input, and the face area label or the non-face area label of each pixel in the sample face occlusion image as an output.

In some alternative implementations of the present embodiment, the apparatus 400 for detecting face occlusion may further include: perform image processing on the to-be-processed face occlusion image to recognize the facial feature, and set the feature points for the facial feature on the to-be-processed face occlusion image.

The present embodiment also provides a terminal device, including: one or more processors; and a storage apparatus, for storing one or more programs, the one or more programs, when executed by the one or more processors, cause the one or more processors to implement the method for detecting face occlusion.

The present embodiment also provides a computer readable storage medium, storing a computer program thereon, the program, when executed by a processor, implements the method for detecting face occlusion.

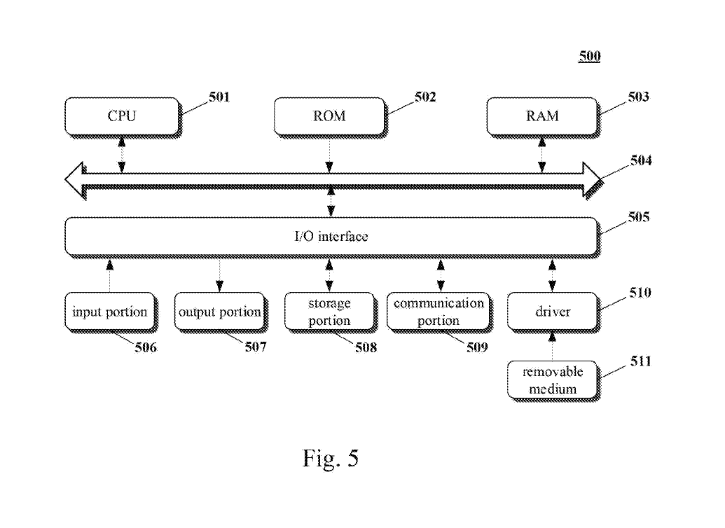

Referring to FIG. 5, a schematic structural diagram of a computer system 500 adapted to implement a terminal device of the embodiments of the present disclosure is shown. The terminal devices shown in FIG. 5 is merely an example and should bring no limitation to the functionality and usage range of the embodiments of the present disclosure.

As shown in FIG. 5, the computer system 500 includes a central processing unit (CPU) 501, which may execute various appropriate actions and processes in accordance with a program stored in a read-only memory (ROM) 502 or a program loaded into a random access memory (RAM) 503 from a storage portion 508. The RAM 503 also stores various programs and data required by operations of the system 500. The CPU 501, the ROM 502 and the RAM 503 are connected to each other through a bus 504. An input/output (I/O) interface 505 is also connected to the bus 504.

The following components are connected to the I/O interface 505: an input portion 506 including a keyboard, a mouse etc.; an output portion 507 comprising a liquid crystal display device (LCD), a speaker etc.; a storage portion 508 including a hard disk and the like; and a communication portion 509 comprising a network interface card, such as a LAN card and a modem. The communication portion 509 performs communication processes via a network, such as the Internet. A driver 510 is also connected to the I/O interface 505 as required. A removable medium 511, such as a magnetic disk, an optical disk, a magneto-optical disk, and a semiconductor memory, may be installed on the driver 510, to facilitate the retrieval of a computer program from the removable medium 511, and the installation thereof on the storage portion 508 as needed.

In particular, according to embodiments of the present disclosure, the process described above with reference to the flow chart may be implemented in a computer software program. For example, an embodiment of the present disclosure includes a computer program product, which comprises a computer program that is embedded in a machine-readable medium. The computer program comprises program codes for executing the method as illustrated in the flow chart. In such an embodiment, the computer program may be downloaded and installed from a network via the communication portion 509, and/or may be installed from the removable media 511. The computer program, when executed by the central processing unit (CPU) 501, implements the above mentioned functionalities as defined by the methods of the present disclosure.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. In the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units or modules involved in the embodiments of the present disclosure may be implemented by means of software or hardware. The described units or modules may also be provided in a processor, for example, described as: a processor, comprising an image acquisition unit, an occlusion information acquisition unit and an information outputting unit, where the names of these units or modules do not in some cases constitute a limitation to such units or modules themselves. For example, the occlusion information acquisition unit may also be described as “a unit for acquiring occlusion information.”

In another aspect, the present disclosure further provides a computer-readable storage medium. The computer-readable storage medium may be the computer storage medium included in the apparatus in the above described embodiments, or a stand-alone computer-readable storage medium not assembled into the apparatus. The computer-readable storage medium stores one or more programs. The one or more programs, when executed by a device, cause the device to: acquire a to-be-processed face occlusion image, the to-be-processed face occlusion image containing a plurality of feature points for marking a facial feature; import the to-be-processed face occlusion image into a pre-trained face occlusion model to obtain occlusion information corresponding to the to-be-processed face occlusion image, the face occlusion model being used to acquire occlusion information of a face by the feature points contained in the to-be-processed face occlusion image; and output the occlusion information.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A method for detecting face occlusion, the method comprising:
acquiring a to-be-processed face occlusion image, the to-be-processed face occlusion image containing a plurality of feature points for marking a facial feature;
importing the to-be-processed face occlusion image into a pre-trained face occlusion model to obtain occlusion information corresponding to the to-be-processed face occlusion image, the face occlusion model being used to acquire occlusion information of a face by the feature points contained in the to-be-processed face occlusion image; and
outputting the occlusion information.

2. The method according to claim 1, wherein the method further comprises constructing the face occlusion model, and the constructing the face occlusion model comprises:
dividing, for each sample face occlusion image in a plurality of sample face occlusion images, a face image in the sample face occlusion image into at least one face area by feature points of the face image, wherein the each sample face occlusion image contains pre-marked feature points;
calculating, for each face area in the at least one face area, a ratio of non-face pixels in the face area to all pixels in the face area to obtain ratio information, and constructing occlusion information of the face area by the ratio information; and
obtaining the face occlusion model through training, by using a machine learning method, with the sample face occlusion image as an input, and the occlusion information of each face area in the sample face occlusion image as an output.

3. The method according to claim 2, wherein the dividing a face image in the sample face occlusion image into at least one face area by feature points of the face image comprises:
importing the sample face occlusion image into a pixel recognition model to obtain a label of a pixel of the sample face occlusion image, wherein the pixel recognition model is used to recognize whether a pixel belongs to the face image, and set a label for the pixel, and the label is used to annotate whether the pixel belongs to the face image;
dividing the sample face occlusion image into the face image and a non-face image by the label; and
dividing the face image into the at least one face area by the feature points.

4. The method according to claim 3, wherein the method further comprises constructing the pixel recognition model, and the constructing the pixel recognition model comprise:
performing feature extraction on the sample face occlusion image to acquire a feature image, the feature image having a size smaller than the sample face occlusion image;
determining a feature image area corresponding to a facial feature on the feature image, the facial feature comprising hair, eyebrows, eyes, and nose;
setting, after mapping the feature image to a size identical to the sample face occlusion image, a face area label for a pixel included in the feature image area, and setting a non-face area label for a pixel not included in the feature image area; and
obtaining the pixel recognition model by training, by using the machine learning method, with the sample face occlusion image as an input, and the face area label or the non-face area label of each pixel in the sample face occlusion image as an output.

5. The method according to claim 1, wherein before the acquiring a to-be-processed face occlusion image, the method further comprises:
performing image processing on the to-be-processed face occlusion image to recognize the facial feature, and setting the feature points for the facial feature on the to-be-processed face occlusion image.

6. An apparatus for detecting face occlusion, the apparatus comprising:
at least one processor; and
a memory storing instructions, the instructions when executed by the at least one processor, cause the at least one processor to perform operations, the operations comprising: acquiring a to-be-processed face occlusion image, the to-be-processed face occlusion image containing a plurality of feature points for marking a facial feature;
importing the to-be-processed face occlusion image into a pre-trained face occlusion model to obtain occlusion information corresponding to the to-be-processed face occlusion image, the face occlusion model being used to acquire occlusion information of a face by the feature points contained in the to-be-processed face occlusion image; and
outputting the occlusion information.

7. The apparatus according to claim 6, wherein the operations further comprise constructing the face occlusion model, and the constructing the face occlusion model comprises:
dividing, for each sample face occlusion image in a plurality of sample face occlusion images, a face image in the sample face occlusion image into at least one face area by feature points of the face image, wherein the each sample face occlusion image contains pre-marked feature points;
calculating, for each face area in the at least one face area, a ratio of non-face pixels in the face area to all pixels in the face area to obtain ratio information, and construct occlusion information of the face area by the ratio information; and
obtaining the face occlusion model through training, by using a machine learning method, with the sample face occlusion image as an input, and the occlusion information of each face area in the sample face occlusion image as an output.

8. The apparatus according to claim 7, wherein the dividing a face image in the sample face occlusion image into at least one face area by feature points of the face image comprises:
importing the sample face occlusion image into a pixel recognition model to obtain a label of a pixel of the sample face occlusion image, wherein the pixel recognition model is used to recognize whether a pixel belongs to the face image, and set a label for the pixel, and the label is used to annotate whether the pixel belongs to the face image;
dividing the sample face occlusion image into the face image and a non-face image by the label; and
dividing the face image into the at least one face area by the feature points.

9. The apparatus according to claim 8, wherein the operations further comprise constructing the pixel recognition model, and the constructing the pixel recognition model comprises:
performing feature extraction on the sample face occlusion image to acquire a feature image, the feature image having a size smaller than the sample face occlusion image;
determining a feature image area corresponding to a facial feature on the feature image, the facial feature comprising hair, eyebrows, eyes, and nose;
setting, after mapping the feature image to a size identical to the sample face occlusion image, a face area label for a pixel included in the feature image area, and set a non-face area label for a pixel not included in the feature image area; and
obtaining the pixel recognition model by training, by using the machine learning method, with the sample face occlusion image as an input, and the face area label or the non-face area label of each pixel in the sample face occlusion image as an output.

10. The apparatus according to claim 6, wherein the operations further comprise:
performing image processing on the to-be-processed face occlusion image to recognize the facial feature, and setting the feature points for the facial feature on the to-be-processed face occlusion image.

11. A non-transitory computer readable storage medium storing a computer program, wherein the computer program, when executed by a processor, cause the processor to perform operations, the operations comprising:
acquiring a to-be-processed face occlusion image, the to-be-processed face occlusion image containing a plurality of feature points for marking a facial feature;
importing the to-be-processed face occlusion image into a pre-trained face occlusion model to obtain occlusion information corresponding to the to-be-processed face occlusion image, the face occlusion model being used to acquire occlusion information of a face by the feature points contained in the to-be-processed face occlusion image; and
outputting the occlusion information.
